(19) United States
(12) Patent Application Publication
(10) Pub. No.: US 2025/0167330 A1
(43) Pub. Date: May 22, 2025

(54) POWER SUPPLY DEVICE

(71) Applicant: TOYOTA JIDOSHA KABUSHIKI KAISHA, Toyota-shi (JP)

(72) Inventor: Naotaka TANIGUCHI, Nagoya-shi (JP)

(73) Assignee: TOYOTA JIDOSHA KABUSHIKI KAISHA, Toyota-shi (JP)

(21) Appl. No.: 18/761,847

(22) Filed: Jul. 2, 2024

(30) Foreign Application Priority Data
Nov. 22, 2023 (JP) 2023-198229

(51) Int. Cl. H01M 10/613; H01M 10/615

(52) U.S. Cl. CPC H01M 10/613; H01M 10/615

(57) ABSTRACT

A battery cell, a heat sink, a joining member for joining the battery cell and the heat sink, and a heater for heating the battery cell are provided. A power supply device comprising: a 1 metal plate joined to a battery cell; and a 2 metal plate joined to the heat sink, wherein the thermal resistance of the 1 metal plate and the 2 metal plate can be changed based on the temperature of the battery cell.

### CROSS-REFERENCE TO RELATED APPLICATION

This application claims priority to Japanese Patent Application No. 2023-198229 filed on Nov. 22, 2023, incorporated herein by reference in its entirety.

### BACKGROUND

### 1. Technical Field

The present disclosure relates to a power supply device including a heat sink with a battery cell.

### 2. Description of Related Art

Japanese Unexamined Patent Application Publication No. 2014-192010 (JP 2014-192010 A) discloses a battery cooling structure for cooling a battery. This JP 2014-192010 A describes a structure in which a battery and a heat sink are thermally coupled to each other via an insulating heat conductive member.

### SUMMARY

There are cases in which temperature of the battery cell is raised by using a heating device such as a heater, in order to increase output of the battery and so forth. In this case, in a structure in which the heat sink is thermally coupled to the battery cell, the heat of the heating device escapes from the heat sink. Thus, there is a problem in that energy efficiency for raising the temperature of the battery cell decreases, and it takes time for the battery cell to rise to a desired temperature.

The present disclosure has been made in view of the above problems, and an object thereof is to provide a power supply device capable of suppressing decrease in energy efficiency when temperature of a battery cell is raised by using a heating device while maintaining heat dissipation performance when cooling the battery cell.

In order to solve the above problem, an aspect of technology of the present disclosure is
a power supply device including
a battery cell,
a heat sink,
a joining member for joining the battery cell and the heat sink, and
a heater for heating the battery cell, in which
the joining member includes a first metal plate that is joined to the battery cell, and a second metal plate that is joined to the heat sink, and thermal resistance of the first metal plate and the second metal plate is changeable based on temperature of the battery cell.

According to the power supply device of the present disclosure, the thermal resistance of the joining member can be dynamically changed in accordance with the temperature of the battery cell. Thus, decrease in energy efficiency when the temperature of the battery cell is raised by using the heating device can be suppressed, while maintaining heat dissipation performance when cooling the battery cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic structural diagram of a power supply device according to an embodiment of the present disclosure;

FIG. 2 is a processing flowchart of heat control of a battery cell executed by a power supply device;

FIG. 3A is a diagram illustrating a state of thermal coupling and a state of isolation of a metal plate;

FIG. 3B is a diagram illustrating a state of thermal bonding and a state of separating a metal plate; and

FIG. 4 is a diagram for explaining a state that the power supply device can take in accordance with thermal control of the battery cell.

### DETAILED DESCRIPTION OF EMBODIMENTS

In the power supply device of the present disclosure, whether the joining member provided between the battery cell and the heat sink is in a state in which the battery cell and the heat sink are thermally coupled to each other or separated from each other is switched in accordance with the temperature of the battery cell. By this switching, the heat dissipation performance via the heat sink is maintained when the battery cell is cooled, and a decrease in the energy efficiency of the heater heat that increases the temperature when the battery cell is heated is suppressed.

Hereinafter, an embodiment of the present disclosure will be described in detail with reference to the drawings.

### Embodiment

### Structure

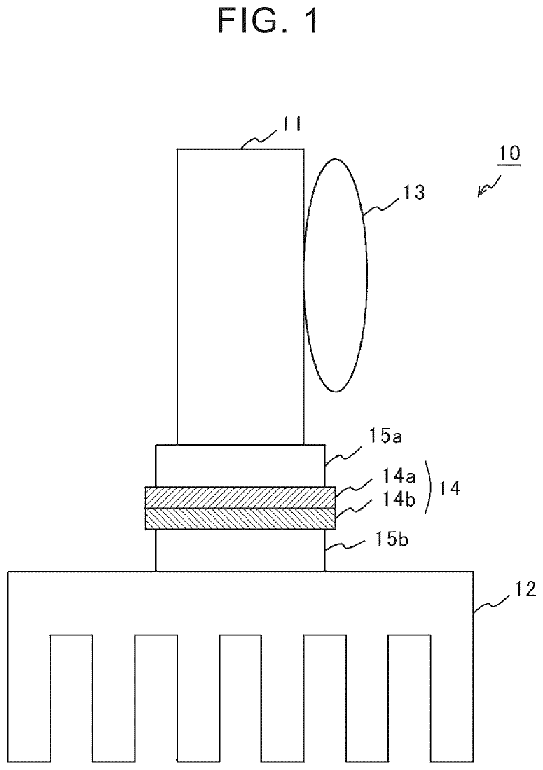

FIG. 1 is a schematic diagram for explaining a structure of a power supply device 10 according to an embodiment of the present disclosure. The power supply device 10 in FIG. 1 includes a battery cell 11, a heat sink 12, a heater 13, a joining member 14, and heat dissipation putty 15a, 15b.

The battery cell 11 is a secondary battery configured to be chargeable and dischargeable, such as a lithium-ion battery.

The heat sink 12 is a heat dissipation member thermally coupled to the battery cell 11 via the joining member 14, the heat dissipation putty 15a, 15b. The heat sink 12 is formed of a member having high thermal conductivity, such as aluminum or copper.

The heater 13 is a heating device for heating the battery cell 11. The heating timing of the battery cell 11 by the heater 13 will be described later. The method of heating by the heater 13 is not particularly limited.

The joining member 14 is provided between the battery cell 11 and the heat sink 12, and is a member for joining the battery cell 11 and the heat sink 12. The joining member 14 includes a first metal plate 14a that is in contact with the battery cell 11 via a heat dissipation putty 15a, and a second metal plate 14b that is in contact with the heat sink 12 via a heat dissipation putty 15b. The first metal plate 14a and the second metal plate 14b are configured to be able to be switched between a state in which the battery cell 11 and the heat sink 12 are thermally coupled or a state in which they are thermally separated depending on the temperature of the battery cell 11. That is, the joining member 14 is configured to be able to change the thermal resistivity of the first metal plate 14a and the second metal plate 14b.

As the first metal plate 14a and the second metal plate 14b, for example, various well-known metal materials can be used, which can deform shapes to form air-like layers that form gaps in part (or all) between both metal plates. In addition, the first metal plate 14a and the second metal plate 14b may be formed as one coupled component or may be two independent components. In order to ensure the heat dissipation performance when the battery cell 11 and the heat sink 12 are thermally coupled to each other, it is desirable to use a member having high thermal conductivity for the first metal plate 14a and the second metal plate 14b.

The heat dissipation putty 15a is configured to thermally couple the battery cell 11 and the first metal plate 14a of the joining member 14. The heat dissipation putty 15b is configured to thermally couple the second metal plate 14b of the joining member 14 and the heat sink 12. Each of the heat dissipation putty 15a and 15b is formed of a member having good insulating properties and thermal conductivity.

### Control

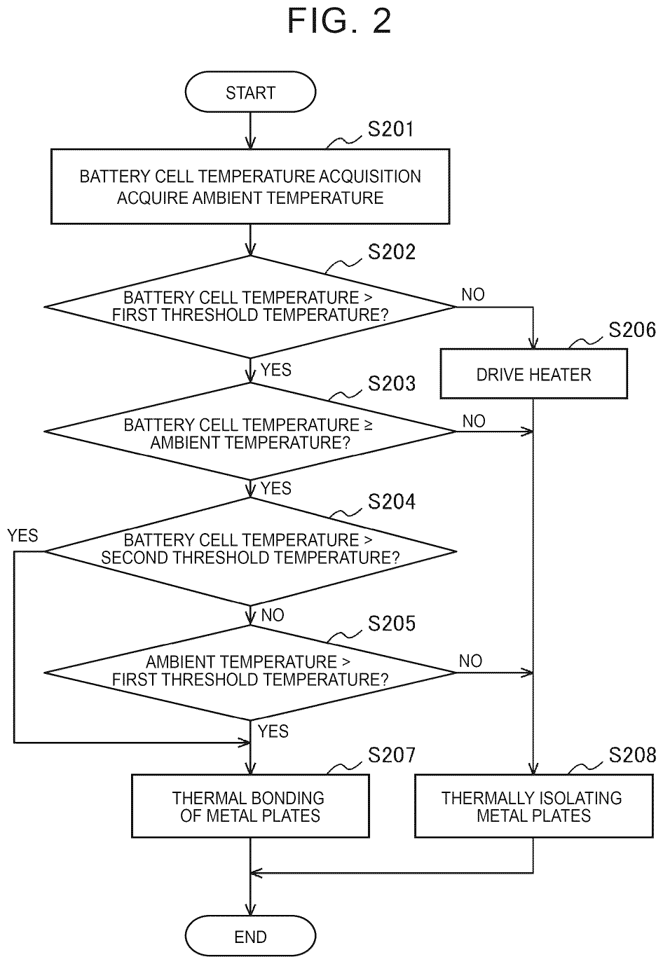

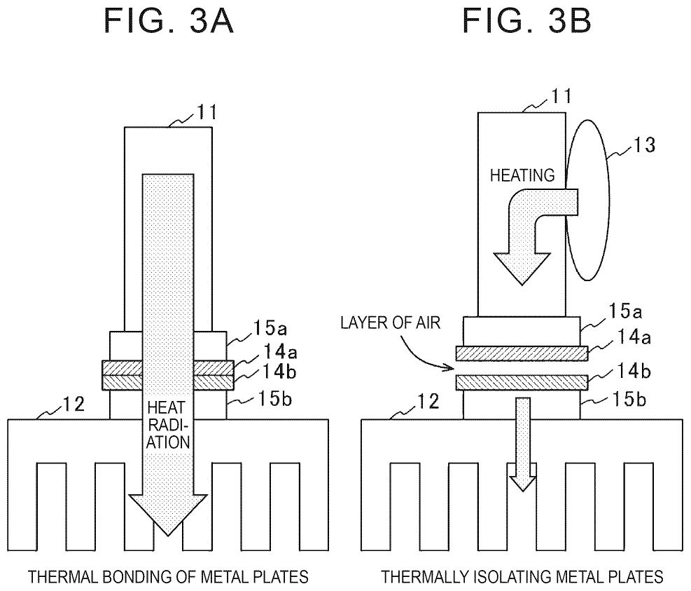

Next, the control performed by the power supply device 10 according to the present embodiment will be described with reference to FIGS. 2, 3A, and 3B. FIG. 2 is a flowchart for explaining a processing procedure of heat control of the battery cell 11 executed by the power supply device 10.

### S201

The power supply device 10 acquires the temperature of the main body of the battery cell 11 (hereinafter, referred to as “battery cell temperature”) and the temperature of the environment in which the battery cell 11 is placed (hereinafter, referred to as “ambient temperature”). The battery cell temperature and the ambient temperature can be acquired using a detection device (not shown) such as a temperature sensor. Among these, the detection device for detecting the battery cell temperature is provided at a position in contact with the battery cell 11, in the vicinity of the battery cell 11, or the like. Further, the detection device for detecting the ambient temperature may be provided in the vicinity of the battery cell 11, or may be provided at another position (such as the outside of the power supply device 10).

When the battery cell temperature and the ambient temperature are acquired in the power supply device 10, the process proceeds to S202.

### S202

The power supply device 10 determines whether or not the battery cell temperature is higher than a predetermined first threshold temperature. This determination is made in order to check whether or not the heater 13 should be driven. Therefore, the first threshold temperature is set to the temperature (low temperature limit value) of the battery cell 11 that needs to be warmed by driving the heater 13.

If the power supply device 10 determines that the battery cell temperature is higher than the first threshold temperature (S202, Yes), the process proceeds to S203. On the other hand, when the power supply device 10 determines that the battery cell temperature is equal to or lower than the first threshold temperature (S202, No), the process proceeds to S206.

### S203

The power supply device 10 determines whether or not the battery cell temperature is equal to or higher than the ambient temperature. This determination is made to confirm whether or not the heat of the battery cell 11 should be allowed to be released from the heat sink 12 (normal state) in order to suppress the temperature of the battery cell 11 from rising.

When the power supply device 10 determines that the battery cell temperature is equal to or higher than the ambient temperature (S203, Yes), the process proceeds to S204. On the other hand, when the power supply device 10 determines that the battery cell temperature is lower than the ambient temperature (S203, No), the process proceeds to S208.

### S204

The power supply device 10 determines whether or not the battery cell temperature is higher than a predetermined second threshold temperature. This determination is made in order to confirm whether or not the battery cell 11 needs to be cooled based on the temperature of the main body of the battery cell 11. The second threshold temperature is set to a value higher than the first threshold temperature.

If the power supply device 10 determines that the battery cell temperature is higher than the second threshold temperature (S204, Yes), the process proceeds to S207. On the other hand, when the power supply device 10 determines that the battery cell temperature is equal to or lower than the second threshold temperature (S204, No), the process proceeds to S205.

### S205

The power supply device 10 determines whether the ambient temperature is higher than the first threshold temperature. This determination is made in order to determine a method for suppressing the temperature rise of the battery cell 11 based on the temperature of the ambient temperature.

If the power supply device 10 determines that the ambient temperature is higher than the first threshold temperature (S205, Yes), the process proceeds to S207. On the other hand, when the power supply device 10 determines that the ambient temperature is equal to or lower than the first threshold temperature (S205, No), the process proceeds to S208.

### S206

The power supply device 10 drives (heats ON) the heater 13. Driving of the heater 13 may be started by a control unit (not shown) such as a microcomputer that acquires the battery cell temperature from the detection device controlling the heater 13. Alternatively, the heater 13 may start driving the heater 13 by itself acquiring the battery cell temperature from the detection device.

When the heater 13 is driven in the power supply device 10, the process proceeds to S208.

### S207

The power supply device 10 brings the first metal plate 14a of the joining member 14 and the second metal plate 14b into a thermally coupled state. In this heat-coupled state, the first metal plate 14a and the second metal plate 14b come into close contact with each other without substantially creating a gap, and the heat resistivity due to the first metal plate 14a and the second metal plate 14b is reduced. FIG. 3A shows an example illustrating a configuration of a power supply device 10 in a thermally coupled state. As shown in FIG. 3A, in the thermal coupling condition, the heat of the battery cell 11 can be discharged from the heat sink 12 via the joining member 14 (the first metal plate 14a, the second metal plate 14b) and the heat dissipation putty 15a, 15b. In other words, the thermal bonding state is a normal state.

Typically, the transition from the present state to the thermally coupled state is realized by the first metal plate 14a and the second metal plate 14b that detect the battery cell temperature and the ambient temperature deform their shapes, respectively. Note that a control unit (not shown) that detects the battery cell temperature and the ambient temperature may act on the first metal plate 14a and the second metal plate 14b to transition from the present state to the thermal coupling state.

When the first metal plate 14a and the second metal plate 14b are thermally coupled to each other in the power supply device 10, the thermal control of the battery cell 11 ends.

### S208

The power supply device 10 thermally separates the first metal plate 14a and the second metal plate 14b of the joining member 14 (thermally separates). In this thermally separated state, a gap is formed between a part or all of the first metal plate 14a and the second metal plate 14b, and the thermal resistivity of the first metal plate 14a and the second metal plate 14b increases. FIG. 3B shows an example illustrating a configuration of a power supply device 10 in a thermally separated condition. As shown in FIG. 3B, in the thermally isolated condition, layers of air are formed. Thus, the heat released (escaped) from the heat sink 12 can be reduced through the joining member 14 (the first metal plate 14a, the second metal plate 14b) and the heat dissipation putty 15a, 15b. Therefore, when the battery cell 11 is heated by the heater 13 (S206, no), the battery cell 11 can be efficiently heated. When the outside air temperature is higher than the temperature of the battery cell 11 (S203, no), it is possible to suppress the battery cell 11 from being warmed up by the outside air. In addition, when the temperature of the battery cell 11 is not desired to be lowered even if the outside air temperature is lower than the temperature of the battery cell 11 (S205, no), it is possible to suppress the battery cell 11 from being cooled to a low temperature by the outside air.

Typically, the transition from the present state to the thermally isolated state is realized by the first metal plate 14a and the second metal plate 14b, which detect the battery cell temperature and the ambient temperature, respectively deforming their shapes. Note that a control unit (not shown) that detects the battery cell temperature and the ambient temperature may act on the first metal plate 14a and the second metal plate 14b to transition from the present state to the thermally isolated state.

When the first metal plate 14a and the second metal plate 14b are thermally separated from each other in the power supply device 10, the thermal control of the battery cell 11 ends.

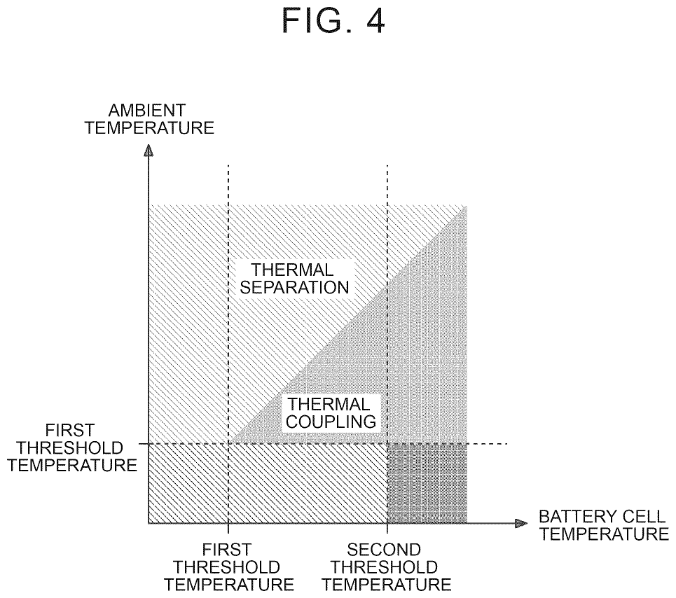

FIG. 4 shows a state that the power supply device 10 can take in accordance with the thermal control of the battery cell 11 described above. As illustrated in FIG. 4, the power supply device 10 appropriately selects the thermal coupling state and the thermal separation state based on the temperature of the battery cell 11 (battery cell temperature), the outside air temperature (ambient temperature), the first threshold temperature, and the second threshold temperature.

### Operations and Effects

As described above, in the power supply device 10 according to the embodiment of the present disclosure, the joining member 14 made of two separable metal plates (the first metal plate 14a and the second metal plate 14b) is sandwiched between the battery cell 11 and the heat sink 12. Then, the power supply device 10 is selectively used by switching the thermal coupling state and the thermal separation state in accordance with the battery cell temperature and the ambient temperature.

By this process, when it is desired to reduce the temperature of the battery cell by allowing the heat of the battery cell 11 to escape to the outside air, the two metal plates (the first metal plate 14a and the second metal plate 14b) of the joining member 14 are thermally coupled to eliminate the gap. Thus, heat can be dissipated from the heat sink 12. Further, when it is desired to raise the temperature of the battery cell where the heat of the battery cell 11 is not desired to escape to the outside air, the two metal plates (the first metal plate 14a and the second metal plate 14b) of the joining member 14 are thermally separated to generate a gap. As a result, it is possible to reduce the amount of heat dissipation from the heat sink 12 by performing heat insulation in the air layer.

Therefore, it is possible to achieve both the maintenance of the heat dissipation performance (low heat resistance) at the time of cooling of the battery cell 11, the shortening of the time at the time of the temperature increase of the battery cell 11 using the heater 13, and the reduction of the power consumption of the heater 13 (suppression of the reduction of the energy efficiency).

The power supply device of the present disclosure can be used in a case where it is desired to achieve both heat dissipation at the time of cooling of the battery cell and temperature rise at the time of heating of the battery cell.

What is claimed is:

1. A power supply device, comprising:
a battery cell;
a heat sink;
a joining member for joining the battery cell and the heat sink; and
a heater for heating the battery cell, wherein the joining member includes a first metal plate that is joined to the battery cell, and a second metal plate that is joined to the heat sink, and thermal resistance of the first metal plate and the second metal plate is changeable based on temperature of the battery cell.

2. The power supply device according to claim 1, wherein, when the temperature of the battery cell is no higher than a predetermined first threshold temperature,
the heater heats the battery cell, and
the joining member thermally separates the first metal plate and the second metal plate to increase the thermal resistance as compared to before the separating.

3. The power supply device according to claim 1, wherein, when the temperature of the battery cell and an ambient temperature exceed a predetermined first threshold temperature, and also the temperature of the battery cell is no lower than the ambient temperature,
the heater does not heat the battery cell, and
the joining member thermally couples the first metal plate and the second metal plate to each other, such that the thermal resistance is lower as compared to before the coupling.

4. The power supply device according to claim 3, wherein, even though the ambient temperature is below the first threshold temperature, when the temperature of the battery cell exceeds a second threshold temperature that is higher than the first threshold temperature,
the heater does not heat the battery cell, and
the joining member thermally couples the first metal plate and the second metal plate to each other, such that the thermal resistance is lower as compared to before the coupling.

5. The power supply device according to claim 1, wherein, when the temperature of the battery cell exceeds a predetermined first threshold temperature and also is lower than an ambient temperature,
the heater does not heat the battery cell, and
the joining member thermally separates the first metal plate and the second metal plate to increase the thermal resistance as compared to before the separating.

6. The power supply device according to claim 5, wherein, even though the temperature of the battery cell is no lower than the ambient temperature, when the ambient temperature is no higher than the first threshold temperature,
the heater does not heat the battery cell, and
the joining member thermally separates the first metal plate and the second metal plate to increase the thermal resistance as compared to before the separating.
